(19) United States
(12) Patent Application Publication
(10) Pub. No.: US 2014/0307752 A1
(43) Pub. Date: Oct. 16, 2014

(54) APPARATUS AND METHOD WHICH CAN INCLUDE CENTER-WAVELENGTH SELECTABLE, BANDWIDTH ADJUSTABLE, SPECTRUM CUSTOMIZABLE, AND/OR MULTIPLEXABLE SWEPT-SOURCE LASER ARRANGEMENT

(71) Applicants: GUILLERMO J. TEARNEY, Cambridge, MA (US); JOSEPH A. GARDECKI, Marlborough, MA (US); PAULINO VACAS JACQUES, Boston, MA (US)

(72) Inventors: GUILLERMO J. TEARNEY, Cambridge, MA (US); JOSEPH A. GARDECKI, Marlborough, MA (US); PAULINO VACAS JACQUES, Boston, MA (US)

(73) Assignee: THE GENERAL HOSPITAL CORPORATION, Boston, MA (US)

(21) Appl. No.: 14/170,819

(22) Filed: Feb. 3, 2014

Related U.S. Application Data
(60) Provisional application No. 61/759,781, filed on Feb. 1, 2013.
(60) Provisional application No. 61/790,340, filed on Mar. 15, 2013.

(51) Int. Cl. H01S 3/105; H01S 3/10

(52) U.S. Cl. CPC H01S 3/105; H01S 3/1003
USPC 372/20

(57) ABSTRACT

Systems, methods and computer-accessible mediums for providing a radiation(s) can be provided. For example, a hardware arrangement can be configured to provide the radiation(s) that can have a wavelength(s) that continuously changes over time and over a predetermined bandwidth with a predetermined envelope in a single sweep. The hardware arrangement can include a gain arrangement and a controller arrangement, and the controller arrangement can be configured to electronically control the gain arrangement such that the wavelength(s) provided by the hardware arrangement (i) spans a subset of the predetermined bandwidth, or (ii) changes a wavelength dependent distribution in the single sweep.

### CROSS-REFERENCE TO RELATED APPLICATION(S)

This application relates to and claims priority from U.S. Patent Application Ser. No. 61/759,781 filed Feb. 1, 2013, and U.S. Patent Application Ser. No. 61/790,340 filed Mar. 15, 2013, the entire disclosures of which are incorporated herein by reference.

### STATEMENT REGARDING FEDERALLY SPONSORED RESEARCH

This invention was made with Government support under grant number 2R01HL076398-06 awarded 1w the National Institute of Health. The Government has certain rights therein.

### FIELD OF THE DISCLOSURE

The present disclosure relates to exemplary embodiments of a swept laser source arrangement, and more particularly to apparatus and method, which can include center-wavelength selectable, bandwidth adjustable, spectrum customizable, and/or multiplexable swept-source laser arrangement.

### BACKGROUND INFORMATION

Considerable efforts have been devoted to a development of rapidly and widely tunable wavelength laser sources for optical reflectometry, biomedical imaging, sensor interrogation and tests and measurements. A narrow line-width, wide-range, and rapid tuning (at rates of at least 100 terahertz per millisecond) have been realized by use of an intracavity narrowband wavelength-scanning filter. Mode-hopping-free single-frequency operation has been demonstrated in an extended-cavity semiconductor laser by employing a diffraction grating filter design. In certain applications, such as biomedical imaging, multiple-longitudinal mode operation, corresponding to an instantaneous line-width as large or greater than 10 GHz is sufficient. A line-width of the order of 10 GHz can be achievable by employing an intracavity-tuning element such as an acousto-optic filter, Fabry-Perot filter, and galvanometer-driven grating filter. The incorporation of a rotating polygon beam scanner has served to demonstrate intracavity wavelength tuning at repetition rates greater than 100 kHz.

Optical Coherence Tomography (OCT), Optical Frequency Domain Imaging (OFDI), and Spectrally Encoded Confocal Microscopy (SECM) benefit from the utilization of a rapidly swept laser source. Specific requirements for such swept source can include broad wavelength sweep range, high repetition rate, and narrow instantaneous linewidth. A 10 GHz instantaneous linewidth, obtained by employing intracavity acousto-optic. Fabry-Perot, galvanometer-driven grating, or polygon beam scanner filters, bestows a ranging depth of several millimeters in OFDI and a micrometer-level transverse resolution in SCEM.

Traditional implementations of rapidly swept laser sources for OCT, OFDI, and/or SCEM exhibit a fixed center-wavelength of emission, a set bandwidth, a predetermined spectrum shape, and a constant spectrum during operation.

Additional optical techniques, including but not limited to fluorescence imaging, targeted (diffuse) spectroscopy, Raman spectroscopy, mesoscopic spectrally encoded tomography, etc., may also benefit from the employment of a rapidly swept laser source.

Optimal or preferable performance of such techniques may require a rapidly swept laser source capable of selecting the center-wavelength, adjusting the bandwidth, customizing the spectrum, and multiplexing complementary imaging modalities. Current state-of-the-art swept laser sources are incapable of providing such flexibility.

Accordingly, there may be a need to address and/or overcome at least some of such deficiencies.

### SUMMARY OF EXEMPLARY EMBODIMENTS

It is one of the objects of the present disclosure to facilitate a rapidly swept laser source configuration (e.g., at rates of at least 100 terahertz per millisecond) to select the center wavelength of emission. In accordance with certain exemplary embodiments of the present disclosure, exemplary methods and apparatus can be provided, which enable the implementation of a center-wavelength selectable swept laser source.

Another exemplary object of the present disclosure is to provide a rapidly swept laser source arrangement with an adjustable bandwidth. A further exemplar object of the present disclosure is to providing a rapidly swept laser source arrangement with a customizable spectrum. Furthermore, yet another exemplary object of the present disclosure is to provide a rapidly swept laser source arrangement that can facilitate the use and/or implementation of multiplexing complementary imaging modalities.

Rapidly swept laser sources, e.g. based on and/or including a polygon scanner, can generate laser light (or other electromagnetic radiation) exclusively when the optical elements are aligned. Polygon scanners and other cavity filters can work at relatively low modulation frequencies (e.g., about 0.1-10 kHz). Further, optical amplifiers (e.g., including semiconductor optical amplifiers, SOA) can operate at considerably higher frequencies (e.g., less than about 10 GHz). Therefore, it is possible to phase-synchronize, amplitude-modulate, and phase-modulate the rapidly swept laser source arrangement(s) according to an exemplary embodiment of the present disclosure.

According to one exemplary embodiment of the present disclosure, a rapidly swept laser source arrangement, configured to select the center-wavelength, can be provided by an exemplary phase-synchronization of the optical amplifier and filter to the center wavelength of interest. In another exemplary embodiment of the present disclosure, a rapidly swept laser source arrangement, with an adjustable bandwidth, can be provided by phase-modulating so as to obtain a bandwidth of interest, while maintaining the phase-synchronization. According to still another exemplary embodiment of the present disclosure, a rapidly swept laser source arrangement with customizable spectrum, can be provided which can utilize and/or implement a train-impulse modulation of the optical amplifier and can modify the magnitude of each impulse/wavelength to fit a desired spectrum.

According to a further exemplary embodiment of the present disclosure, a comb-like spectrum can be obtained by employing train-impulse modulation with constant current or optical-power of the optical amplifier output.

In another exemplary embodiment of the present disclosure, a multiplexable laser output can be provided. The exemplary rapidly swept laser source arrangement(s) can be utilized to generate one spectrum at a first sweep and a second (third, etc.) spectrum at a second (third, etc.) sweep by modifying the phase-synchronization, amplitude-modulation, and/or phase-modulation of the rapidly swept laser source arrangement(s).

The flexibility provided by the rapidly swept laser source described herein may facilitate a resolution optimization in OFDI/SECM systems, for example. Furthermore, the exemplary embodiment of the swept-source laser arrangement according to the present disclosure can be employed to generate representations of Optical Frequency Domain Imaging (OFDI) and Spectrally Encoded Confocal Microscopy (SECM) with varying laser bandwidths.

Other possible, and certainly not all-inclusive, applications are possible in accordance with the exemplary embodiments of the present disclosure. As an initial matter, e.g., exemplary differential absorption OFDI/SECM systems can be implemented by performing a first OFDI/SECM scan at full bandwidth and a second (third, etc.) scan of the same sample with the full bandwidth without specific wavelength(s). Multiplexed OFDI/SECM and targeted-diffuse spectroscopy modalities can be implemented by performing a first OFDI/SECM scan at full bandwidth and a second (third, etc.) scan of the same sample with a narrow (including single wavelength) bandwidth. Multiplexed OFDI and targeted-spectroscopic OFDI modalities can be implemented by performing a first OFDI scan at full bandwidth and a second (third, etc.) scan of the same sample with a narrow (including single wavelength) bandwidth. Multiplexed OFDI and mesoscopic spectrally encoded tomography modalities can be implemented by performing a first OFDI scan at full bandwidth and a second (third, etc.) sweep of the same sample with rapid discrete scans over the full bandwidth. Speckle reduction techniques, extra-narrow linewidth, and novel complex conjugate compensation techniques for OFDI can be implemented with the system described herein. Structured illumination for SCEM can be implemented by employing a comb-like spectrum of the laser source. For example, by selecting a single wavelength of the laser source, rapid Raman and fluorescence spectroscopy can also be performed.

These and other objects of the present disclosure can be achieved by provision of systems, methods and computer-accessible mediums for providing a radiation(s). For example, a hardware arrangement can be configured to provide the radiation(s) that can have a wavelength(s) that continuously changes over time, over a predetermined bandwidth, with a predetermined envelope in a single sweep. The hardware arrangement can include a gain arrangement and a controller arrangement, and the controller arrangement can be configured to electronically control the gain arrangement such that the wavelength(s) provided by the hardware arrangement (i) can span a subset of the predetermined bandwidth, or (ii) can change a wavelength dependent distribution in the single sweep.

In some exemplary embodiments of the present disclosure, the subset or the wavelength dependent distribution can have a shape of a comb, or an arbitrary shape. The gain arrangement can include a semiconductor optical amplifier, and the controller arrangement can control the gain arrangement by changing a current administered to the semiconductor optical amplifier, in certain exemplary embodiments of the present disclosure, a filter arrangement be configured to change the wavelength(s) over time. According to additional exemplary embodiments of the present disclosure, a further arrangement can be configured to control or detect a characteristic of the filter arrangement, and the controller arrangement and the further arrangement can be synchronized in a predetermined manner, which can be a phase locking.

The controller arrangement can control the gain arrangement by (i) a phase modulation or (ii) an amplitude modulation that can be associated with the phase locking. In some exemplary embodiments of the present disclosure, the filter arrangement can include a spinning polygon mirror, a tunable Fabry Perot filter, a galvanometer, or a spinning mirror. In certain exemplary embodiments of the present disclosure, the wavelength(s) can be changed by the hardware arrangement over time at a rate of at least 100 terahertz per millisecond, or at a rate of at least 10 terahertz per millisecond.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF DRAWINGS

Further objects, features and advantages of the present disclosure will become apparent from the following detailed description taken in conjunction with the accompanying figures showing illustrative embodiments of the present disclosure, in which:

FIG. 1 is set of illustrations, including a schematic diagram of a system having a fiber sigma ring cavity embodiment of a rapidly swept laser source arrangement, according to an exemplary embodiment of the present disclosure;

FIG. 2A is a circuit diagram of electronics facilitating a phase synchronization in the exemplary swept-source laser arrangement capable and facilitated to select a center-wavelength of interest according to another exemplary embodiment of the present disclosure:

FIG. 2B is a set of exemplary graphs utilized for selecting the center-wavelength according to another exemplary embodiment of the present disclosure;

FIG. 3A is a circuit diagram of electronics facilitating the phase synchronization and a phase modulation in the exemplary swept-source laser arrangement capable and facilitated to adjust the bandwidth according to another exemplary embodiment of the present disclosure;

FIG. 3B is a set of graphs illustrating an exemplary variation of the emission bandwidth, all according to an exemplary exemplary embodiment of the present disclosure;

FIG. 4 is a set of exemplary OFDI illustrations obtained by the rapid variation of bandwidth, according to another exemplary embodiment of the present disclosure;

FIG. 5 is a set of graphs providing an exemplary illustration of the customizable spectrum capability provided by train-impulse modulation, of the optical amplifier providing a comb-like spectrum according to an exemplary embodiment of the present disclosure;

FIG. 6 is a set of graphs providing an exemplary illustration of a multiplexable laser output utilized with the exemplary system, method and apparatus according to an exemplary embodiment of the present disclosure; and

FIG. 7 is an illustration of procedure(s) to provide exemplary phase-synchronization and phase-modulation instructions which can be used in a microcontroller to generate a determined central-wavelength and bandwidth of emission, according to an exemplary embodiment of the present disclosure.

Throughout the drawings, the same reference numerals and characters, unless otherwise stated, are used to denote like features, elements, components, or portions of the illustrated embodiments. Moreover, while the present disclosure will now be described in detail with reference to the figures, it is done so in connection with the illustrative embodiments and is not limited by the particular embodiments illustrated in the figures.

### DETAILED DESCRIPTION OF EXEMPLARY EMBODIMENTS

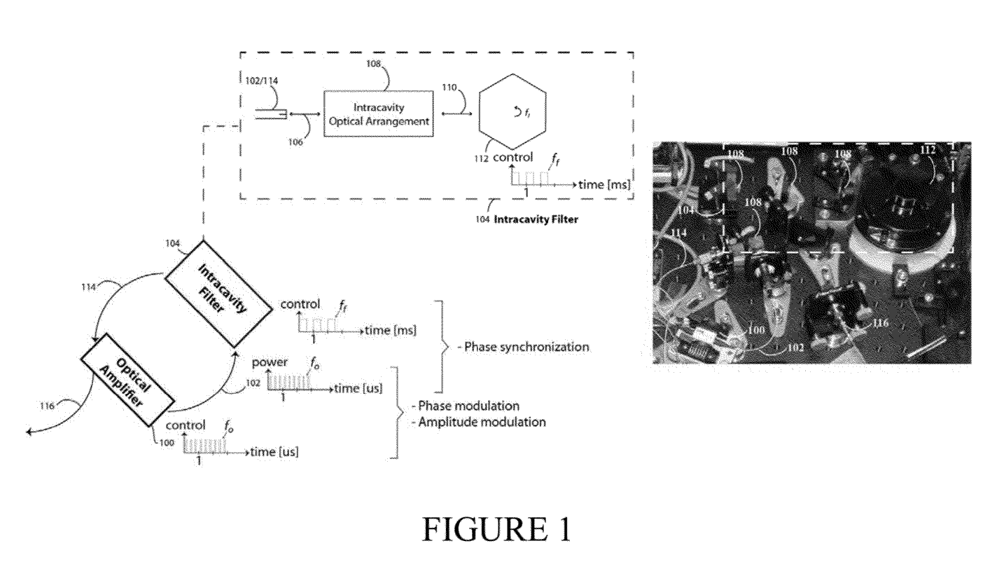

FIG. 1 shows a schematic diagram of a system according to an exemplary embodiment of the present disclosure with a fiber sigma ring cavity of a rapidly swept laser source arrangement with certain exemplary components: e.g., an intracavity filter and an optical amplifier. The exemplary filter is illustrated in FIG. 1 as a polygon-based scanner, working at relatively low modulation frequencies (f_{f}˜0.1-10 kHz). Further, the exemplary optical amplifier can be or include a semiconductor optical amplifier capable of significantly greater modulation frequencies (fₒ˜10 GHz). Phase-synchronization, amplitude modulation, and phase modulation are shown in the graphs of FIG. 1 for the exemplary swept laser source arrangement, according to an exemplary embodiment of the present disclosure.

For example, as shown in FIG. 1, an optical amplifier 100, with its corresponding driving electronics, can be modulated at frequency modulated broadband light 102 (or other electromagnetic radiation) can be transmitted to an intracavity filter 104. An intracavity light 106 (or other electromagnetic radiation) can pass through an optical arrangement 108. A resultant light 110 (or other electromagnetic radiation) can then reach an intracavity scanner 112. The exemplary scanner 112 can be polygon-based with its corresponding driving electronics modulated at frequency f_{f}. An exemplary phase synchronization between the optical amplifier 100 and the intracavity filter 104 can be employed to select different bandwidths and to enable imaging multiplexing. By utilizing exemplary phase and/or amplitude modulation(s), in addition to phase synchronization, it is possible to vary the bandwidth and customizing the emission spectrum. The light or other electromagnetic radiation) 106 returning from the scanner 110 can pass through an intracavity optical arrangement 108, and a further forwarded light/radiation 114 can reach the optical amplifier 100. For example, a laser light/radiation 116 can be obtained after several round trips in the exemplary cavity.

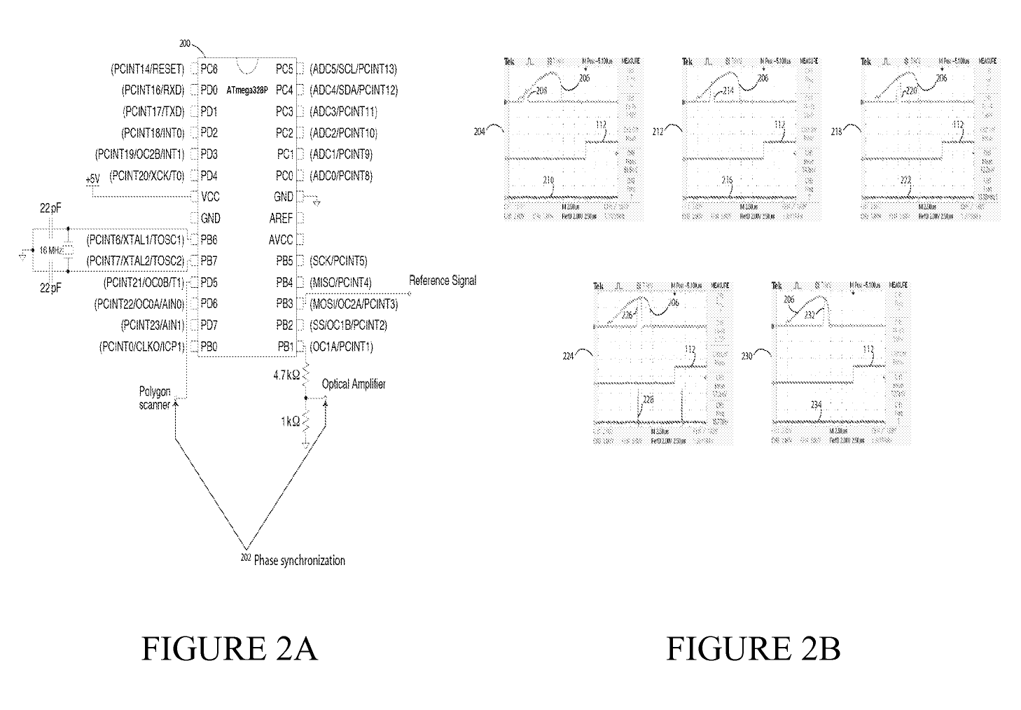

FIG. 2A shows a circuit diagram of electronics facilitating a phase synchronization in the exemplary swept-source laser arrangement capable of selecting the center-wavelength. The choosing of the center-wavelength of interest is also depicted, according to another exemplary embodiment of the present disclosure. In particular, as shown in FIG. 2A, a microcontroller 200 can be employed to perform the phase synchronization (via its outputs 202) between the polygon scanner and the optical amplifier. Two synchronized timers are utilized for such purpose. For example, as shown in the exemplary graphs of FIG. 2B, the exemplary phase can be varied sequentially (see exemplary graphs 204, 212, 218, 224, and 230). The laser output(s) 208, 214, 220, 226, 232 illustrated in FIG. 2A can therefore be scanned through most and likely all possible wavelengths 206 provided by the exemplary optical amplifer and the exemplary filter. The filter signal 112 can be taken as reference. Further, the signal obtained from a reflection of a Bragg grating, e.g., centered at about 1310 nm, is shown in FIG. 2B as numerals 210, 216, 222, 228, and 234. Exemplary elements shown in FIG. 2A are as follows: the microcontroller 200 and phase synchronization outputs 202.

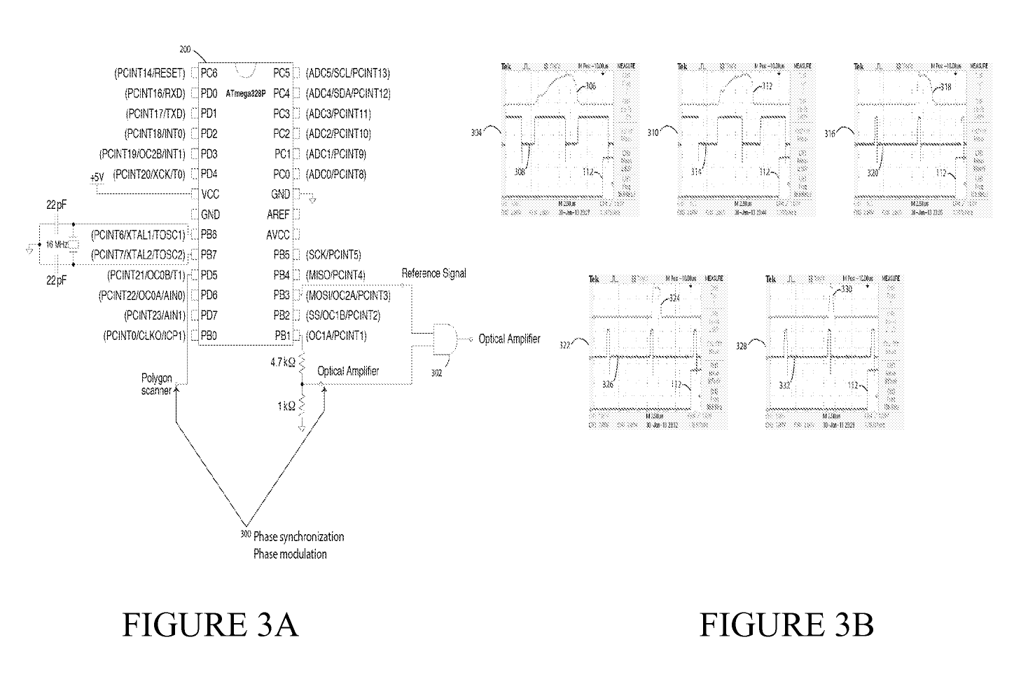

FIG. 3A illustrates a circuit diagram of electronics facilitating the phase synchronization and a phase modulation in the exemplary swept-source laser arrangement configured to adjust the bandwidth according to an exemplary embodiment of the present disclosure. In particular, as shown in FIG. 3A, a microcontroller 200 can be employed to perform phase synchronization and phase modulation (via its outputs 300) between the exemplary polygon scanner and the exemplary optical amplifier. FIG. 3B illustrates a set of graphs providing an exemplary configuration to facilitate a variation of the emission bandwidth, according to another exemplary embodiment of the present disclosure.

As shown in FIG. 3B, an additional AND gate 302 can be utilized for a higher frequency modulation. Three or more synchronized timers can be used for such purpose. The exemplary phase modulation can be varied sequentially as shown by numerals 304, 310, 316, 322, and 328 while maintaining the phase synchronization. The laser bandwidth can be varied from full bandwidth 306, e.g., 80% at numeral 312, 45% at numeral 318, 25% at numeral 324, to finally 12% at numeral 330. The filter signal 112 can be taken as reference. Further, the signal obtained from the reflection of a Bragg grating, after passing through a monostable multivibrator, is also shown as numerals 308, 314, 320, 326, 332. Exemplary elements in FIG. 3 are as follows: the microcontroller 200 an AND gate 302, and phase synchronization and phase modulation outputs 300.

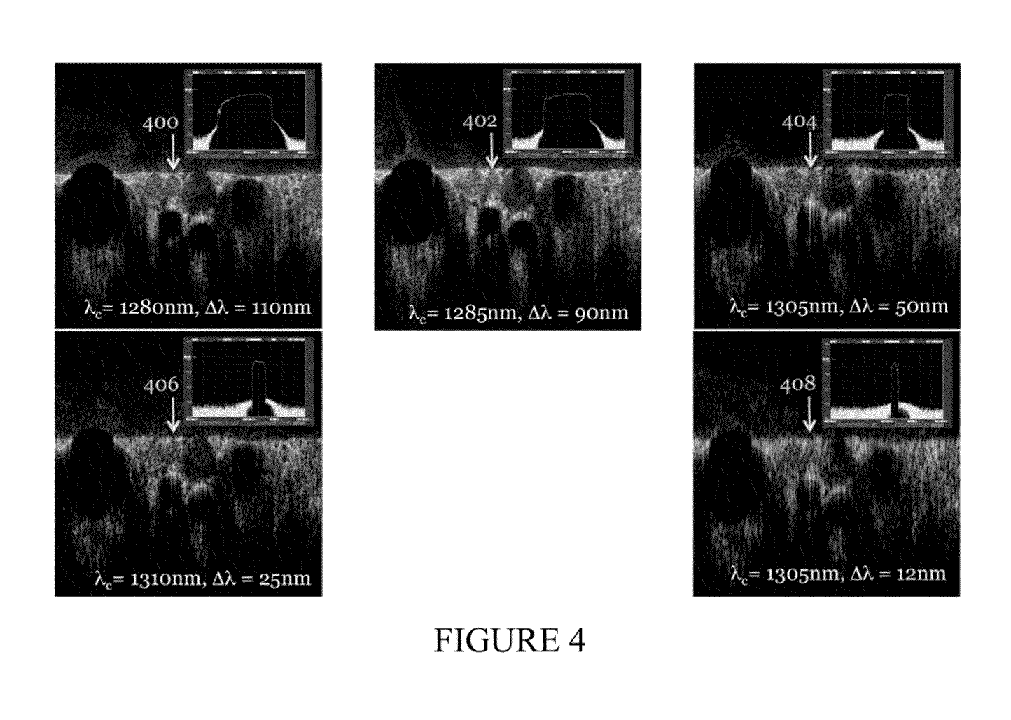

FIG. 4 illustrates a set of exemplary OFDI illustrations obtained by the rapid variation of bandwidth using the exemplary system and/or method, according to another exemplary embodiment of the present disclosure. For example, as shown in FIG. 4, the exemplary OFDI illustrations with varying laser bandwidths are provided The laser bandwidth can be varied from about 110 mm (e.g., center wavelength about 1280 nm) at numeral 400, 90 nm (center wavelength at about 1285 nm) at numeral 402, 50 nm (e.g., center wavelength at about 1305 nm) at numeral 404, 25 nm (center wavelength at about 1310 nm) at numeral 406, to finally 12 nm (center wavelength at about 1305 nm) at numeral 408.

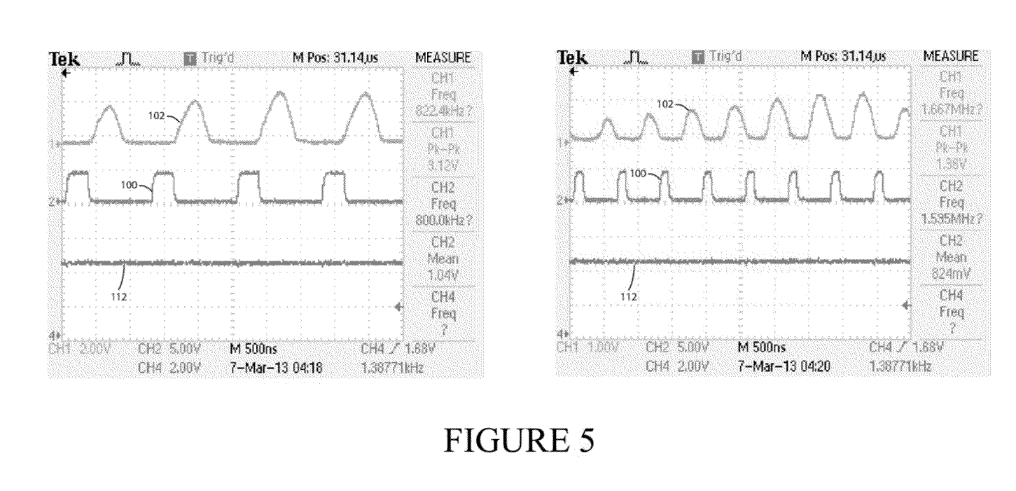

FIG. 5 shows a set of graphs indicating a demonstration of the customizable spectrum capability provided by a train-impulse modulation of the exemplary optical amplifier according to an exemplary embodiment of the present disclosure. For example, a comb-like spectrum can be generated and depicted in the illustrations of FIG. 5, according to another exemplary embodiment of the present disclosure. In particular, as shown in FIG. 5, the phase synchronization (e.g., between the exemplary polygon scanner and the exemplary optical amplifier) and the train-impulse modulation—as shown via numeral 100—of the exemplary optical amplifier can facilitate the generation of a comb-like spectra 102. The exemplary filter signal 112 can be taken as reference. An exemplary filter frequency can be, e.g., ˜1.4 kHz, whereas the optical amplifier can oscillate at, e.g., ˜800 kHz or 1.6 MHz, i.e., providing about 1000 times higher modulation frequencies. Even greater frequencies and thus a narrower comb-like spectra can be generated with a radio-frequency driver for the optical amplifier, according to still another exemplary embodiment of the present disclosure.

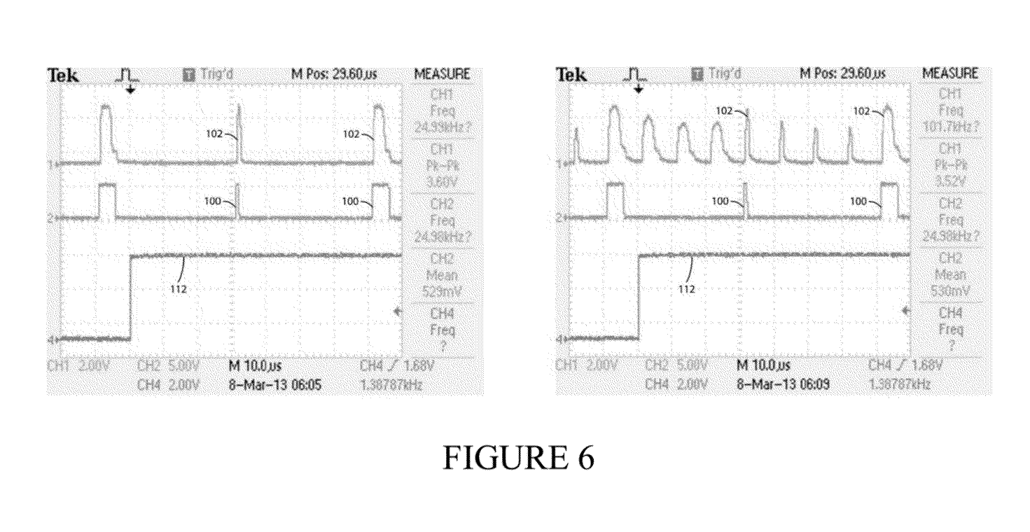

FIG. 6 illustrates a set of further graphs indicating a demonstration of a multiplexable laser output that can be provided and/or utilized with the exemplary system, apparatus and method according to various exemplary embodiments of the present disclosure. The exemplary rapidly swept laser source arrangement can be employed to generate an exemplary spectrum having a determined bandwidth at a first sweep and a second spectrum, e.g., being about five times narrower, at a second sweep by modifying the exemplary phase-synchronization and the exemplary phase-modulation of the rapidly swept laser source arrangement, according to still another exemplary embodiment of the present disclosure. For example, as shown in in FIG. 6, the exemplary phase synchronization (e.g., between the exemplary polygon scanner and the exemplary optical amplifier) and the exemplary phase modulation of the exemplary optical amplifier can be varied dynamically—see numeral 100—during sweeps to generate spectra with varying bandwidths 102. The filter signal 112 can be taken as reference. In this multiplexable scheme according to an exemplary embodiment of the present disclosure, as shown in FIG. 6, the exemplary bandwidth can be selected to be, e.g., about five times broader for the first sweep(s), and then narrower for the following, e.g., with 25 kHz and 100 kHz signals being illustrated.

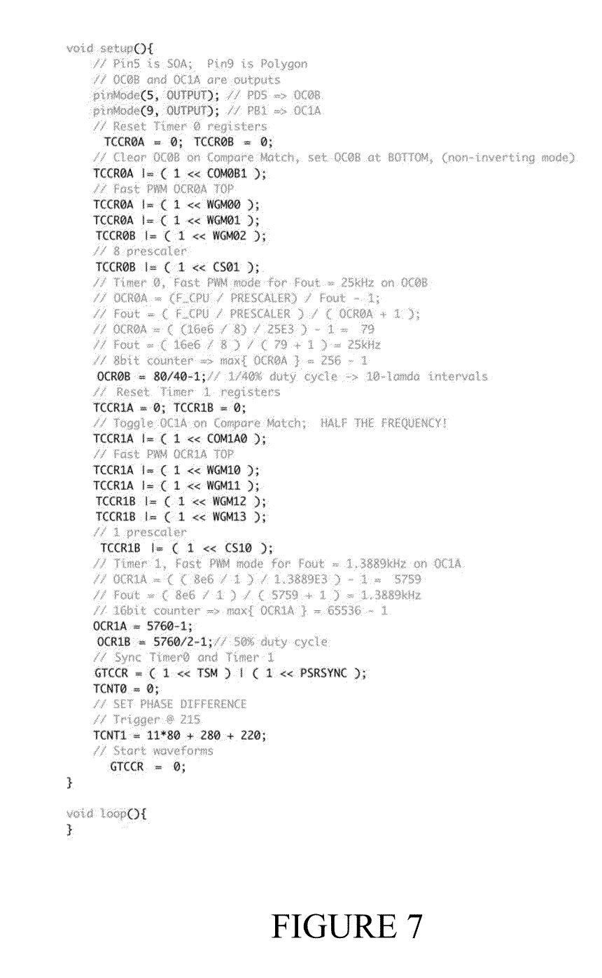

FIG. 7 shows a set of exemplary phase-synchronization and phase-modulation instructions which can be used in a microcontroller 200 to generate a determined central-wavelength and bandwidth of emission, according to an exemplary embodiment of the present disclosure.

The foregoing merely illustrates the principles of the disclosure. Various modifications and alterations to the described embodiments will be apparent to those skilled in the art in view of the teachings herein. Indeed, the arrangements, systems and methods according to the exemplary embodiments of the present disclosure can be used with and/or implement an OCT system OFDI system, SD-OCT system or other imaging systems, and for example with those described in International Patent Application PCT/US2004/029148, filed Sep. 8, 2004 which published as International Patent Publication No. WO 2005/047813 on May 26, 2005, U.S. patent application Ser. No. 11/266,779, filed Nov. 2, 2005 which published as U.S. Patent Publication No. 2006/0093276 on May 4, 2006, and U.S. patent application Ser. No. 10/501,276, filed Jul. 9, 2004 which published as U.S. Patent Publication No. 2005/0018201 on Jan. 27, 2005, and U.S. Patent Publication No. 2002/0122246, published on May 9, 2002, the disclosures of which are incorporated by reference herein in their entireties. It will thus be appreciated that those skilled in the art will be able to devise numerous systems, arrangements, and procedures which, although not explicitly shown or described herein, embody the principles of the disclosure and can be thus within the spirit and scope of the disclosure. In addition, all publications and references referred to above can be incorporated herein by reference in their entireties. It should be understood that the exemplary procedures described herein can be stored on any computer accessible medium, including a had drive, RAM, ROM, removable disks, CD-ROM, memory sticks, etc., and executed by a processing arrangement and/or computing arrangement which can be and/or include a hardware processors, microprocessor, mini, macro, mainframe, etc., including a plurality and/or combination thereof. In addition, certain terms used in the present disclosure, including the specification, drawings and claims thereof, can be used synonymously in certain instances, including, but not limited to, e.g., data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it can be explicitly being incorporated herein in its entirety. All publications referenced above can be incorporated herein by reference in their entireties.

What is claimed is:

1. An apparatus for providing at least one radiation, comprising:
a hardware arrangement which is configured to provide the at least one radiation that has at least one wavelength which continuously changes over time and over a predetermined bandwidth with a predetermined envelope in a single sweep,
wherein the hardware arrangement includes a gain arrangement and a controller arrangement, and
wherein the controller arrangement is configured to electronically control the gain arrangement such that the at least one wavelength provided by the hardware arrangement at least one of (i) spans a subset of the predetermined bandwidth, or (ii) changes a wavelength dependent distribution in the single sweep.

2. The apparatus according to claim 1, wherein at least one of the subset or the wavelength dependent distribution has a shape of a comb.

3. The apparatus according to claim 1, wherein at least one of the subset or the wavelength dependent distribution has an arbitrary shape.

4. The apparatus according to claim wherein the gain arrangement includes a semiconductor optical amplifier.

5. The apparatus according to claim 4, wherein the controller arrangement controls the gain arrangement by changing a current administered to the semiconductor optical amplifier.

6. The apparatus according to claim 5, further comprising a filter arrangement which is configured to change the at least one wavelength over time.

7. The apparatus according to claim 6, further comprising a further arrangement which is configured to control or detect a characteristic of the filter arrangement, wherein the controller arrangement and the further arrangement are synchronized in a predetermined manner.

8. The apparatus according to claim 7, wherein the predetermined manner of the synchronization of the controller arrangement and the further arrangement is a phase locking scheme.

9. The apparatus according to claim 8, wherein the controller arrangement controls the gain arrangement by at least one of (i) a phase modulation, or (ii) an amplitude modulation that is associated with the phase locking.

10. The apparatus according to claim 6, wherein the filter arrangement comprises at least one of a spinning polygon mirror, a tunable Fabry Perot filter, a galvanometer or a spinning mirror.

11. The apparatus according to claim 1, wherein the at least one wavelength is changed by the hardware arrangement over time at a rate of at least 100 terahertz per millisecond.

12. The apparatus according to claim 1, wherein the at least one wavelength is changed by the hardware arrangement over time at a rate of at least 10 terahertz per millisecond.
